(19) United States
(12) Patent Application Publication
(10) Pub. No.: US 2014/0108570 A1
(43) Pub. Date: Apr. 17, 2014

(54) SYSTEM, METHOD AND COMPUTER PROGRAM PRODUCT FOR THREADING A MESSAGE

(71) Applicant: salesforce.com, inc., San Francisco, CA (US)

(72) Inventor: Jyoti M. Khubchandani, Fremont, CA (US)

(73) Assignee: salesforce.com, inc., San Francisco, CA (US)

(21) Appl. No.: 14/047,974

(22) Filed: Oct. 7, 2013

Related U.S. Application Data
(60) Provisional application No. 61/712,393, filed on Oct. 11, 2012.

(51) Int. Cl. H04L 12/58

(52) U.S. Cl. CPC H04L 51/00
USPC 709/206

(57) ABSTRACT

In accordance with embodiments, there are provided mechanisms and methods for threading a message. These mechanisms and methods for threading a message can enable more detailed message sending and receiving, improved data analysis, optimized customer experience, etc.

### CLAIM OF PRIORITY

This application claims the benefit of U.S. Provisional Patent Application No. 61/712,393, entitled “SYSTEM AND METHOD FOR EMAIL THREADING,” by Jyoti M. Khubchandani, filed Oct. 11, 2012(Attorney Docket No. 1068PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to message sending and receiving, and more particularly to threading messages.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Many systems allow for the sending and receiving of messages within the system. Unfortunately, techniques for managing such incoming and outgoing messages have been associated with various limitations. Just by way of example, messages may be sent and received within a system without identifying a history of additional messages associated with a particular message. Accordingly, it is desirable to provide techniques that allow for the threading of a message.

### BRIEF SUMMARY

In accordance with embodiments, there are provided mechanisms and methods for threading a message. These mechanisms and methods for threading a message can enable more detailed message sending and receiving, improved data analysis, optimized customer experience, etc.

In an embodiment and by way of example, a method for threading a message is provided. In one embodiment, a message is received. Additionally, an identifier is extracted from the message. Further, the message is threaded, utilizing the identifier.

While one or more implementations and techniques are described with reference to an embodiment in which threading a message is implemented in a system having an application server providing a front end for an on-demand database system capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for threading a message, in accordance with one embodiment;

FIG. 2 illustrates a method for threading an email message, in accordance with another embodiment;

FIG. 3 illustrates an exemplary response email message, in accordance with another embodiment;

FIG. 4 illustrates another exemplary response email message, in accordance with another embodiment;

FIG. 5 illustrates a block diagram of an example of an environment wherein an on-demand database system might be used; and

FIG. 6 illustrates a block diagram of an embodiment of elements of FIG. 5 and various possible interconnections between these elements.

### DETAILED DESCRIPTION

### General Overview

Systems and methods are provided for threading a message.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for threading a message will be described with reference to example embodiments.

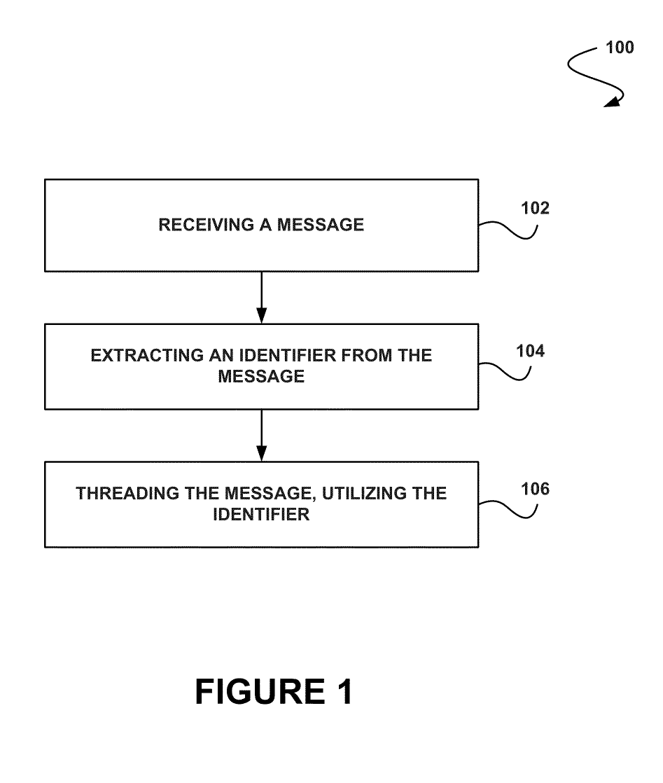

FIG. 1 illustrates a method 100 for threading a message, in accordance with one embodiment. As shown in operation 102, a message is received. In one embodiment, the message may include an electronic message (e.g., an electronic mail message, a short message service (SMS) message, a text message, etc.). In another embodiment, the message may be received at a system. For example, the message may be received at a multi-tenant, on-demand database system. In yet another embodiment, the message may be received utilizing one or more applications of the system. In still another embodiment, the message may be received over a network (e.g., a wired network, a wireless network, a cellular network, etc.).

Additionally, in one embodiment, the message may be received in response to the sending of another message. For example, the message that is received may be sent by a user in response to the receipt of another message by the user. In another embodiment, the message may be received at the system in response to the sending of another message, utilizing the system. For example, a first user may send a first message to a second user utilizing an application provided by the system, and the first user may receive a second message from the second user in response to the first message, where the second message is received utilizing the application of the system.

Also, it should be noted that, as described above, such multi-tenant on-demand database system may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database system will be set forth in the context of different embodiments that will be described during reference to subsequent figures.

Further, as shown in operation 104, an identifier is extracted from the message. In one embodiment, the identifier may be included within the message. In another embodiment, the identifier may be appended to and/or encoded in a field of the message. For example, the message may include an electronic mail (email) message with a plurality of fields (e.g., a field indicating a subject of the message, a field indicating one or more recipients of the message, a field indicating the sender of the message, a field indicating the body of the message, etc.). Additionally, the identifier may be appended to one or more fields of the message.

Further still, in one embodiment, the identifier may include a message identifier that indicates another message associated with the received message. For example, the identifier may identify a message that the received message is responsive to. For instance, the identifier may identify a previous message that was previously received by a user (e.g., at a separate system, utilizing a separate application, etc.), where the received message was drafted and sent by the user in response to the previously received message. In another embodiment, the identifier may be included as part of a data model of the message.

Also, in one embodiment, the identifier may be appended to the message when the message is sent. For example, the message may be sent from a sender to a recipient, and the identifier may be appended to the message by an application at a system utilized by the sender to send the message. In another embodiment, additional identifiers may be associated with (and extracted by) the message. For example, the message may include identifiers that indicate an entity (e.g., an organization, etc.) associated with a sender and/or recipient of the message, a case associated with a sender and/or recipient of the message, etc. In yet another embodiment, the identifier of the case may be derived from the message identifier.

In addition, in one embodiment, the message may be associated with a case of the system. For example, the case may include an object within the system. For example, the case may be stored as a case object (e.g., a table, etc.) within a database of the system. In another embodiment, the case may be associated with an account of the system. For example, the case may be stored in association with an account established within the system. In yet another embodiment, the case may be associated with a customer. For example, the case may include an object stored by a provider of a product or service that is associated with a customer of the provider.

Furthermore, in one embodiment, the case may be created within the system in response to one or more user actions. For example, the case may be automatically or manually created within the system in response to the submission of data by one or more users. In another embodiment, the case may be associated with one or more customer issues within the system. For example, the case may include an indication of one or more questions posed by one or more customers, one or more problems presented by one or more customers, feedback provided by one or more customers, etc.

Further still, in one embodiment, the case may include one or more parameters. For example, the parameters may include an identifier of an associated account, a case number (that may be automatically assigned), a date and time when the case was opened and/or dosed, an identifier of a contact associated with the case, a textual description of the case, an indication of whether the case is open or closed, a source of the case, etc. In another embodiment, each of the one or more parameters of the case may be included within a field of the case, associated with one or more categories of the case, etc.

In another embodiment, the identifier may be conditionally extracted from one or more fields of the message. For example, the message may include a parent message field that includes a message identifier of an earlier message to which the current message is responsive, if such an earlier message exists. In another example, if the current message is not responsive to an earlier message (e.g., the current message has no parent message), the parent message field may be left blank.

Also, as shown in operation 106, the message is threaded, utilizing the identifier. In one embodiment, the received message may be stored within the system. For example, the received message may be stored as an object (e.g., a message object, an email object, etc.) within the system, where the object may include a table or other data structure. In another embodiment, the identifier may be stored as a field of the object. For example, the message object may include a plurality of fields, where each of the fields stores data for a particular identifier within the message. In yet another embodiment, the object may be associated with a case of the system, an organization of the system, etc.

Additionally, in one embodiment, threading the message may include grouping the message with one or more additional messages. For example, threading the message may include grouping the message with one or more messages that the received message is responsive to (e.g., written in response to, etc.). In another embodiment, the message may be logically grouped with one or more additional messages. For example, the message may be stored as an object within a data structure of the system and may be linked to one or more additional messages that are also stored as objects in the data structure of the system.

In another example, the data structure of the system may be associated with an organization of the system, a case within the system, etc. In yet another example, the data structure may include a logical organization of data (e.g., a tree structure, etc.), and data associated with the message (e.g., one or more of an identifier of the message, a body of the message, a subject of the message, a sender of the message, one or more recipients of the message, etc.) may be stored within the data structure. For example, the received message may be stored within a tree structure as a child (e.g., leaf node, etc.), and a message to which the received message is responsive may be stored within the tree structure as a parent (e.g., parent node, etc.).

Further, in one embodiment, threading the message may include visually grouping the message with one or more additional messages. For example, the message may be displayed to one or more users of the system, and data associated with the one or more additional messages may be displayed to the one or more users in addition to data associated with the message. For instance, a body, subject, sender and recipient of the received message may be displayed to a user of the system, as well as one or more of a body, subject, sender and recipient of one or more messages that the received message is responsive to.

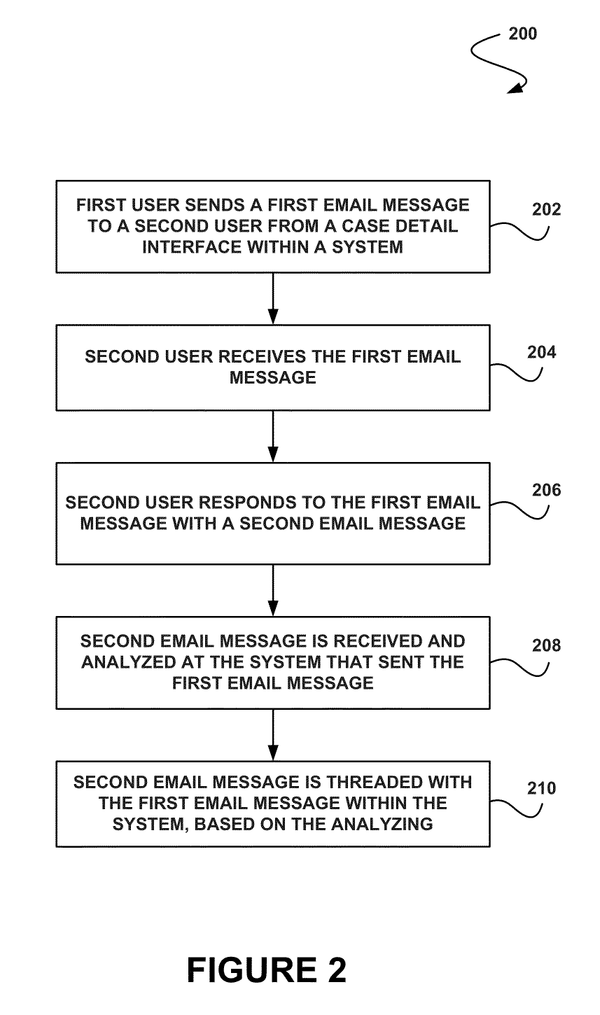

FIG. 2 illustrates a method 200 for threading an email message, in accordance with another embodiment. As an option, the present method 200 may be carried out in the context of the functionality of FIG. 1. Of course, however, the method 200 may be carried out in any desired environment. The aforementioned definitions may apply during the present description.

As shown in operation 202, a first user sends a first email message to a second user from a case detail interface within a system. In one embodiment, the first user may be logged in to the system. For example, the first user may be logged in to the system in association with a particular organization. Additionally, the first user may identify and select a case from within the organization, and may be directed to the case detail interface in response to the selection. Further, the first user may utilize an icon or other selectable element from within the case detail interface to send the email message to the second user.

In another embodiment, an identifier of the first email message may be included within the first email message. For example, the identifier of the first email message may be included within a parent email field of the first email message. In another example, the identifier of the first email message may be encoded within and/or appended to one or more of the subject of the first email message, the body of the first email message, a sender and/or recipient field of the first email message, or any other field of the first email message. In another embodiment, the first email message may also include an identifier of the organization associated with the first email message/first user (e.g., the identifier of the first user), an identifier of the case associated with the first message/first user, etc.

Additionally, as shown in operation 204, the second user receives the first email message. In one embodiment, the second user may receive the first email message at a recipient system separate from the system that sent the first email message. For example, the second user may receive the first email message at a client system, utilizing an email message application installed on the client system. In another embodiment, the second user may receive the first email message utilizing the same system that sent the first email message. For example, the second user may be logged in to a client organization within the same system and may receive the first email message within the organization of the same system. In yet another embodiment, the first email message may include one or more of an identifier of the first email message, an identifier of the case from which the email message was sent, an identifier of the organization from which the email message was sent, etc.

Further, as shown in operation 206, the second user responds to the first email message with a second email message. In one embodiment, the second user may draft and send the second email message utilizing the email message application installed on the client system. In another embodiment, the second user may draft and send the second email message utilizing an application within the client organization of the system that sent the first email message.

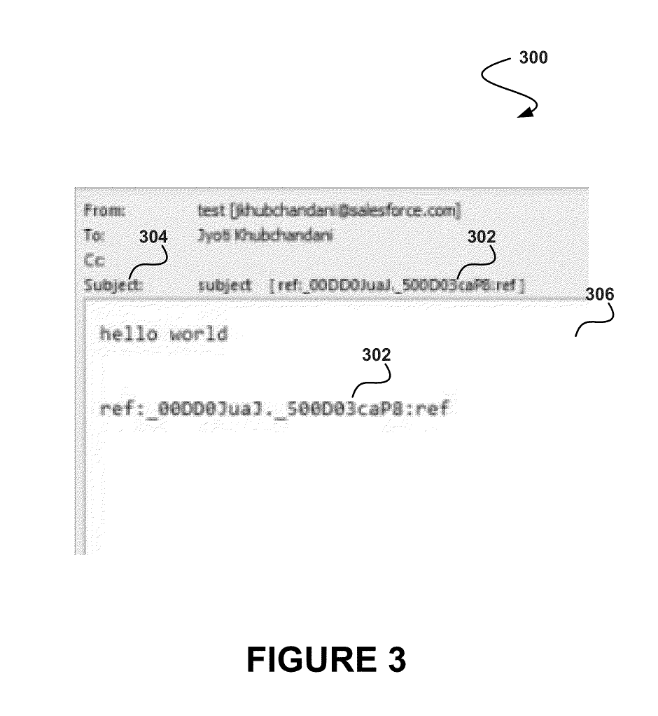

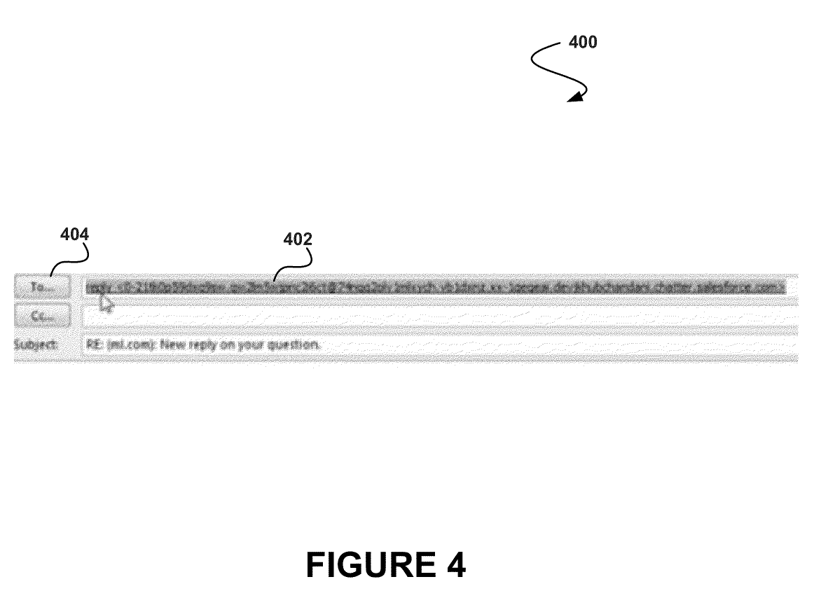

Further still, in one embodiment, an identifier of the first email message may be included within the second email message. For example, the identifier of the first email message may be included within a parent email field of the second email message. In another example, the identifier of the first email message may be encoded within and/or appended to one or more of the subject of the second email message, the body of the second email message, a sender and/or recipient field of the second email message, or any other field of the second email message another embodiment, the second email message may also include an identifier of the organization associated with the first email message/first user (e.g., the identifier of the first user), an identifier of the case associated with the first message/first user, etc. FIG. 3 illustrates an exemplary response email message 300 that includes an email message identifier 302 in both the subject 304 and body 306 of the email message 300. FIG. 4 illustrates another exemplary response email message 300 that includes an email message identifier 402 in a recipient field 404 and of the email message 400.

Also, as shown in operation 208, the second email message is received and analyzed at the system that sent the first email message. In one embodiment, analyzing the second email message may include extracting the identifier of the first email message from a portion of the second email message if the identifier is encoded within the first email message. In another embodiment, analyzing the second email message may include determining whether a parent email field of the second email message contains any data (e.g., an identifier of the first email message, etc), and retrieving such data if it exists.

In addition, in one embodiment, analyzing the second email message may include extracting the identifier of the organization associated with the first user and/or an identifier of the case associated with the first user from the second email message another embodiment, the identifier of the organization and/or the case may be derived from the identifier of the first email message. For example, the identifier of the first email message may be stored in a database of the system in association with the identifier of the organization of the first user and/or the identifier of the case of the first user from which the first email message was sent. Additionally, a query may be sent to the database of the system with the identifier of the first email message that was extracted from the second email message, and such identifier may be used to identify and retrieve the identifier of the organization of the first user and/or the identifier of the case of the first user that is associated with the identifier of the first email message.

Also, in one embodiment, the second email message may be sent to an organization and case within the system, based on an identifier of the organization and case within the system. For example, an identifier of the organization and case from which the first email message was sent may be extracted or derived from the second email message, and the second email message may be delivered to such organization and case.

Furthermore, as shown in operation 210, the second email message is threaded with the first email message within the system, based on the analyzing. In one embodiment, threading the second email message with the first email message may include storing the second email message as a child of the first email message within a data structure of the system. In another embodiment, such a data structure may be associated with the first user, the organization and/or case from which the first user sent the first email message, etc.

Further still, in one embodiment, threading the second email message with the first email message may include displaying the second email message in association with the first email message. For example, the second email message may be displayed to the first user along with one or more portions of the first email message (e.g., all or a portion of the body, the subject, the sender, the recipient, etc.). In this way, the second email message may be tied to the first email message within the system, based on information derived from the second email message.

Also, in one embodiment, the identifier of the first email message may be appended in the subject and email body of the second email message when the first email message is replied to, such that the second email message can be threaded with the first email message. For example, the subject and body can be appended with [compressed_orgid:compressed_emailid]. In another example, when replying to an email with id 02sD0000000nfx4 in organization with id 00DD0000000JWUy, the subject and body of the email may be appended with [00DD0JWUy:02sD00nfx4]. When a customer replies to this email, the email may be threaded with the email 02sD0000000nfx4. In this way, unambiguous and accurate threading of incoming emails may be enabled.

### System Overview

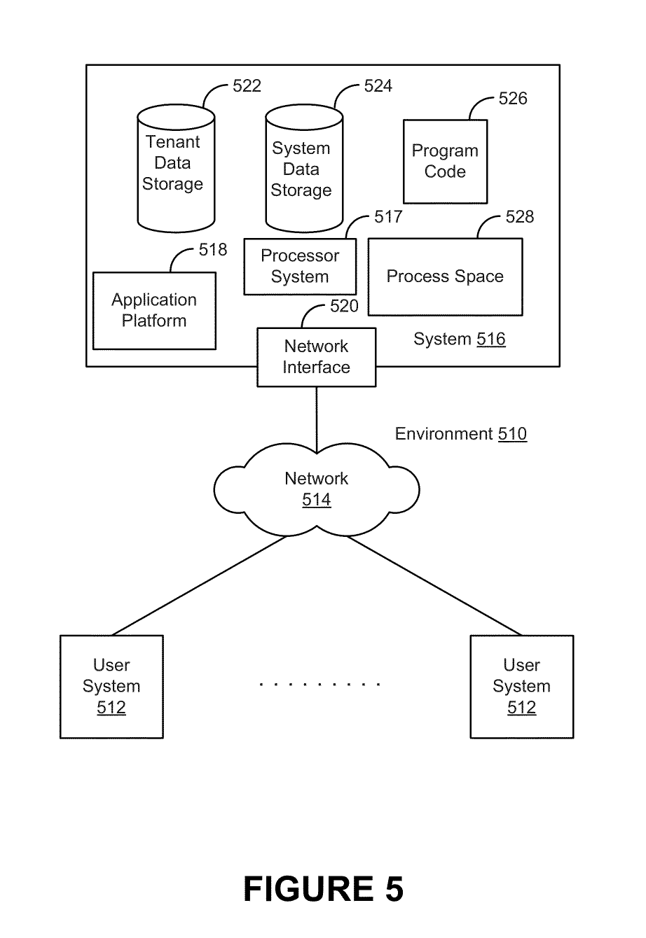

FIG. 5 illustrates a block diagram of an environment 510 wherein an on-demand database system might be used. Environment 510 may include user systems 512, network 514, system 516, processor system 517, application platform 518, network interface 520, tenant data storage 522, system data storage 524, program code 526, and process space 528. In other embodiments, environment 510 may not have all of the components listed and/or may have other elements instead of, or in addition to, those listed above.

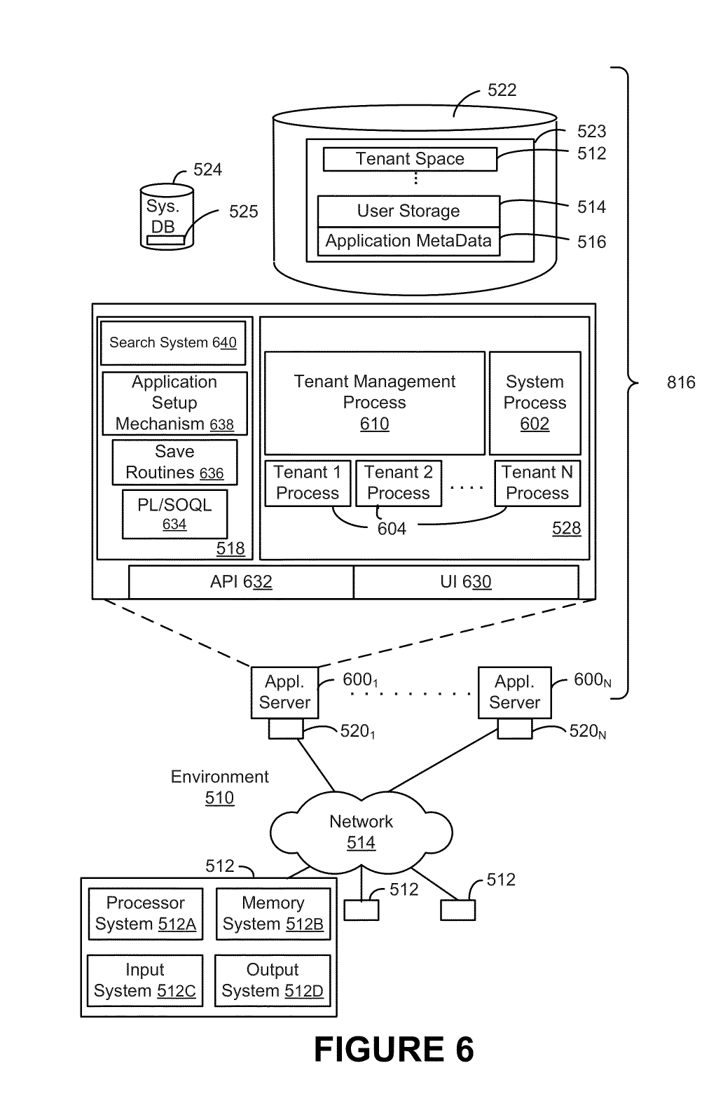

Environment 510 is an environment in which an on-demand database system exists. User system 512 may be any machine or system that is used by a user to access a database user system. For example, any of user systems 512 can be a handheld computing device, a mobile phone, a laptop computer, a work station, and/or a network of computing devices. As illustrated in FIG. 5 (and in more detail in FIG. 6) user systems 512 might interact via a network 514 with an on-demand database system, which is system 516.

An on-demand database system, such as system 516, is a database system that is made available to outside users that do not need to necessarily be concerned with building and/or maintaining the database system, but instead may be available for their use when the users need the database system (e.g., on the demand of the users). Some on-demand database systems may store information from one or more tenants stored into tables of a common database image to form a multi-tenant database system (MTS). Accordingly, “on-demand database system 516” and “system 516” will be used interchangeably herein. A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database system 516 may include an application platform 518 that enables creation, managing and executing one or more applications developed by the provider of the on-demand database system, users accessing the on-demand database system via user systems 512, or third party application developers accessing the on-demand database system via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

in one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third party developer) applications, which may or may not include CRM, may be supported by the application platform 518, which manages creation, storage of the applications into one or more database objects and executing of the applications in a virtual machine in the process space of the system 516.

One arrangement for elements of system 516 is shown in FIG. 5, including a network interface 520, application platform 518, tenant data storage 522 for tenant data 523, system data storage 524 for system data 525 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop, PDA, cell phone, or any wireless access protocol (WAP) enabled device or any other computing device capable of interfacing directly or indirectly to the Internet or other network connection. User system 512 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 512 to access, process and view information, pages and applications available to it from system 516 over network 514. Each user system 512 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Pentium® processor or the like. Similarly, system 516 (and additional instances of an MTS, where more than one is present) and all of their components might be operator configurable using application (s) including computer code to run using a central processing unit such as processor system 517, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 510. However, in FIG. 6 elements of system 516 and various interconnections in an embodiment are further illustrated. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 6001-600N, system process space 602, tenant process spaces 604, tenant management process space 610, tenant storage area 612, user storage 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of one or more processors. Memory system 512B may be any combination of one or more memory devices, short term, and/or long term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 6, system 516 may include a network interface 520 (of FIG. 5) implemented as a set of HTTP application servers 600, an application platform 518, tenant data storage 522, and system data storage 524. Also shown is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage areas 612, which can be either a physical arrangement and/or a logical arrangement of data. Within each tenant storage area 612, user storage 614 and application metadata 616 might be similarly allocated for each user. For example, a copy of a user's most recently used (MRU) items might be stored to user storage 614. Similarly, a copy of MRU items for an entire organization that is a tenant might be stored to tenant storage area 612. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 604 managed by tenant management process 610 for example. Invocations to such applications may be coded using PL/SOQL 634 that provides a programming language style interface extension to API 632. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 6001 might be coupled via the network 514 (e.g., the Internet), another application server 600N−1 might be coupled via a direct network link, and another application server 600N might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing a load balancing function (e.g., an F5 Big-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., one or more SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product embodied on a tangible computer readable medium, comprising:
computer code for receiving a message;
computer code for extracting an identifier from the message; and
computer code for threading the message, utilizing the identifier.

2. The computer program product of claim 1, wherein the message includes an electronic mail message.

3. The computer program product of claim 1, wherein the identifier is appended to one or more fields of the message.

4. The computer program product of claim 1, wherein the identifier includes a message identifier that indicates another message associated with the received message.

5. The computer program product of claim 1, wherein an identifier of a case is derived from the message identifier.

6. The computer program product of claim 5, wherein the case is associated with one or more customer issues within the system.

7. The computer program product of claim 5, wherein the case includes one or more of an indication of one or more questions posed by one or more customers, one or more problems presented by one or more customers, and feedback provided by one or more customers.

8. The computer program product of claim 1, wherein the message includes a parent message field that includes a message identifier of an earlier message to which the message is responsive.

9. The computer program product of claim 8, wherein if the message is not responsive to an earlier message, the parent message field is left blank.

10. The computer program product of claim 1, wherein the received message is stored as a message object within the system, where the message object includes a table.

11. The computer program product of claim 10, wherein the identifier is stored as a field of the message object.

12. The computer program product of claim 1, wherein the stored message object is associated with a case of the system.

13. The computer program product of claim 1, wherein threading the message includes grouping the message with one or more additional messages.

14. The computer program product of claim 1, wherein the message is stored as an object within a data structure of the system and is linked to one or more additional messages that are also stored as objects in the data structure of the system.

15. The computer program product of claim 14, wherein the data structure includes a tree structure.

16. The computer program product of claim 15, wherein the received message is stored within a tree structure as a child node, and a message to which the received message is responsive is stored within the tree structure as a parent node.

17. The computer program product of claim 1, wherein threading the message includes visually grouping the message with one or more additional messages.

18. The computer program product of claim 17, further comprising displaying the message to one or more users of the system, where data associated with the one or more additional messages is displayed to the one or more users in addition to data associated with the message.

19. A method, comprising:
receiving a message;
extracting an identifier from the message; and
threading the message, utilizing the identifier.

20. An apparatus, comprising:
a processor for:
receiving a message;
extracting an identifier from the message; and
threading the message, utilizing the identifier.

21. A method for transmitting code for use in a multi-tenant database system on a transmission medium, the method comprising:
transmitting code for receiving a message;
transmitting code for extracting an identifier from the message; and
transmitting code for threading the message, utilizing the identifier.
